(19) United States
(12) Patent Application Publication
(10) Pub. No.: US 2021/0176193 A1
(43) Pub. Date: Jun. 10, 2021

(54) A SYSTEM AND METHOD FOR BRIDGING COMPUTER RESOURCES

(71) Applicant: BAMBOO SYSTEMS GROUP LIMITED, Cambridgeshire (GB)

(72) Inventors: Giampictro Tecchiolli, Trento (IT); Anthony John Goodacre, Cambridgeshire (GB)

(73) Assignee: BAMBOO SYSTEMS GROUP LIMITED, Cambridgeshire (GB)

(21) Appl. No.: 16/972,361

(22) PCT Filed: May 21, 2019
(86) PCT No.: PCT/GB2019/051405

§ 371 Date: Dec. 4, 2020

(30) Foreign Application Priority Data
Jun. 6, 2018 (GB) 1809299.9

(51) Int. Cl. H04L 12/937; H04L 12/931; H04L 12/911; G06F 13/40

(52) U.S. Cl. CPC H04L 49/254; G06F 13/4027; H04L 47/781; H04L 49/602

(57) ABSTRACT

A computer system comprising a processor, a plurality of peripheral resources, and reconfigurable hardware interconnecting the processor and the plurality of peripheral resources. The reconfigurable hardware is arranged to define a control plane interconnecting the processor and the plurality of peripheral resources and a data plane interconnecting the processor and the plurality of peripheral resources, and to carry out bridging between the plurality of peripheral resources through the data plane. The processor is arranged to control the bridging through the control plane.

The present application relates to a system and method for the bridging of computer peripheral resources.

### BACKGROUND

Two general forms of computer architecture are known. One is a general purpose processor (GPP) architecture, in which peripheral resources are connected to and controlled by a central processing unit (CPU) via a standard bus, such as Peripheral Component Interconnect Express (PCIe). The other is an application specific integrated circuit (ASIC) architecture, in which the required peripheral resources are connected directly to an ASIC processor comprising a CPU.

In both of these computer architectures, in order to bridge access between different peripheral resources the CPU must control, and must generally manage, the movement and conversion of transferred data between the formats required by the different peripheral resources. In order to enable data access to a peripheral resource a host and physical layer communications stack is normally used, typically these layers are identified by the Open Systems Interconnection (OSI) model of communication system abstraction layers 1 to 7.

In the OSI model only functions operating at a particular abstraction layer in a communication stack of a data path on one side of a client/server can know the context of data at the corresponding layer of the communication stack of the data path on the other side of the client/server. In applications where it is necessary to bridge data transfers between two different communications stacks this can only be implemented by components that implement the same abstraction layer within the two communications stacks. For example, if it is required to place the data from a storage device using its storage communication stack with a network device using its network communication stack, the data must pass through the entire storage communication stack to the application, at Layer 7, before being bridged to the network communication stack. In addition, although both stacks may carry out Direct Memory Access (DMA) at the transport layer 4, using similar operations, they are fundamentally ignorant of the meaning of the data at different levels of the enclosed data, they are only capable of moving data and providing a limited conversion with respect to the data movement and the data structures required by specific resources at their level of communication stack with the layers above and below their stacks.

Recently, smart switches have been developed for operation across the layers of their networking communication stack. Such smart switches in addition to operating in the media layers or physical layers 1 to 3 of the communication stack are able to inspect the data packets associated with the host layers 4 to 7 in order to enable more intelligent operation at the lower layers of the network stack. This smart switching approach may refer to the layer 3 and below of the communication stack as a data plane, with a separate control plane providing the rules on how the information derived from the data packets on the upper layers 4 to 7 should be interpreted and used to alter the operation on the data plane.

Further, ASICs may be used to provide bridging for a single type of peripheral resource between different instances of the resource at the same level of a communication stack because in this case there is no need to convert the structure of the transferred data. For example, a network element that reads data packets from one port, a network layer 3 resource, inspects each data packet, and bridges the data packet to another port, also a network layer 3 resource. Furthermore, advanced ASICs may be used to bridge between two specific different resources, for example to enable network access to a disk drive, but such an ASIC can only bridge between specific peripheral resources, it cannot provide general bridging between other generic resource types.

In these conventional approaches, in order to perform general bridging between different resource layer stacks associated with different peripheral resources it is necessary to use a CPU of a GPP or ASIC to run software to implement the general bridging of the peripheral resources while maintaining an entire ISO protocol stack for each peripheral resource.

An explanatory example of this is shown in FIG. 3, where a CPU 100 is connected to a data store 101 and to a network 102 through a network switch 103. In order for an application to communicate with the network, it must have a communication stack 104, and to communicate with the storage, an additional communication stack 105. For the application to provide network access to the storage the CPU 100 will need to carry out processing to move the data through all the levels 7 to 2 of the communication stack 104, and then move the data through all of levels 7 to 2 of the different communication stack 105 of the data store 101.

A problem with this approach is that there are significant computational overheads involved in moving the data up and down the respective protocol stacks of the different peripheral resources.

Another problem is that if there is any miss-match between the processing capability of the CPU and the performance of the peripheral resources the performance of the bridging will be limited by the least capable of the two components. For example, creating a distributed network using multiple data stores and multiple clients will require data to flow across the entire network and data storage, but a modern solid-state drive (SSD) can deliver a latency that is less than that of software to access stored data, or the bandwidth of a network can exceed the capability of a bridging processor, so that the potential performance of the distributed network which could, in theory, be provided by its component parts may not be realizable in practice.

The approach described above may be further described as having an architectural split between the operations associated with management of the communications stack, known as the control plane, and the data plane associated with the movement and potential manipulation of the data between resources. An explanatory example of this concept is shown in FIG. 4, where a CPU 200 is connected to a network adapter or network port 201 and a data store 202. As is shown in FIG. 4 the network port 201 is connected to the CPU 200 by a respective control plane 203a and data plane 204a, and the data store 202 is connected to the CPU 200 by a respective control plane 203b and data plane 204b.

There is some standardization to define Application Programming Interfaces (APIs) that allow generalized control of abstracted data planes, but these are limited to data paths in which the lower layers of the communication stack are the same, for example where the stacks are associated with the movement of network packets between only network ports, and therefore such API do not address the general case of data movement between any type and any number of resources. In an additional example, the implementation of communication stacks in which resource devices are attached to the CPU through a PCIe interface can in cooperation create a data plane between devices, but this is only at the lowest levels of the communication stack, and each stack must be made aware of the other stack. In addition, these API do not provide the capability to a session through a communication stack to provide alternative access points into the communication stack. These fundamental architecture limitations are common to both the GPP and ASIC approach for the bridging of resources, so that generally the flexibility of a GPP cannot achieve the performance theoretically available from the peripheral resources and to bridge different resources, and the performance of a ASIC cannot provide the flexibility to bridge any general combination of resources. Further, the provision of a path that can bridge multiples of different types of resources would suffer even more from the GPP performance shortcomings and would be impractically complex to try to provide using an ASIC.

The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A system and method is provided in which the control plane and data plane from any number of resources is attached to a reconfigurable hardware and only the control aspects of the bridge is run on the CPU. In effect, the layers of the ISO stack hosted on the CPU are exposed to a generalized switch between multiple and heterogeneous lower layers, so that without full transversal of the ISO stack for each resource, different resources can connect directly with each other, and also share sessions between different instances of any host stack.

In a first aspect, the present disclosure provides a computer system comprising: a processor; a plurality of peripheral resources; and reconfigurable hardware interconnecting the processor and the plurality of peripheral resources; wherein the reconfigurable hardware is arranged to define a control plane interconnecting the plurality of peripheral resources and a data plane interconnecting the processor and the plurality of peripheral resources, and to carry out bridging between the plurality of peripheral resources through the data plane; and the processor is arranged to control the bridging through the control plane.

In a second aspect, the present disclosure provides a method for carrying out bridging between a plurality of peripheral resources, the method comprising: providing reconfigurable hardware interconnecting the plurality of peripheral resources and a processor and defining a control plane interconnecting the plurality of peripheral resources and a data plane interconnecting the processor and the plurality of peripheral resources; operating the reconfigurable hardware under the control of the processor through the control plane to carry out bridging between the plurality of peripheral resources through the data plane.

In a third aspect, the present disclosure provides a method for carrying out bridging between a plurality of peripheral resources interconnected by reconfigurable hardware defining a control plane interconnecting the plurality of peripheral resources and a data plane interconnecting a processor and the plurality of peripheral resources, the method comprising: operating the reconfigurable hardware under the control of the processor through the control plane to carry out bridging between the plurality of peripheral resources through the data plane.

In a fourth aspect, the present disclosure provides a computer program comprising computer readable instructions which, when executed on a processor, will cause the processor to carry out the method of any of the second aspect or the third aspect.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is an explanatory diagram of a conceptual illustration of a computer system architecture according to an embodiment;

FIG. 2 is an explanatory diagram of computer system according to an embodiment;

FIG. 3 is an explanatory diagram of a known computer system architecture; and

FIG. 4 is an explanatory diagram of a known computer system.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

A basic concept of the present invention is a computer system architecture in which the control planes and data planes from any number of computer peripheral resources are attached to a reconfigurable switching hardware and only the bridge control is run on an attached processor. In effect, the host layers of the ISO stack used to access the peripheral resources are exposed to a generalized switch between multiple and heterogenous physical layers, so that different peripheral resources can connect directly with each other without full transversal of the ISO stack for each resource being required, and also share sessions between different instances of the host stack.

The proposed architecture enables the application control plane to adapt to information within the data plane at hardware speeds while merging the control planes of multiple resources to provide a meta-control plane to the processor. The control plane is associated with managing a peripheral resource, while the data plane is associated with the movement and potential manipulation of data between different resources.

For example, the merging of the control planes of storage and networking into the reconfigurable switching hardware will expose the knowledge of the communication stacks between the storage resource and the network while enabling the bridging of remote storage requests directly to another network interface, while also bridging data from the associated data plane of this bridge to a CPU. This enables the scenario of a CPU access to a storage disk to be maintained, with the reconfigurable switching hardware arbitrating storage requests between an immediately connected disk, and a network connecting to disks distributed across a network without requiring CPU involvement in otherwise bridging between the application layers of the associated communication stacks.

As explained above, in the new computer system architecture, only the bridge control is run on an attached processor, such as a CPU, and the host layers of the communication stack may be connected to different peripheral resources without the CPU needing to move the data through the full communication stack. Accordingly, the computational overheads involved in moving the data up and down the respective protocol stacks of the different peripheral resources will be reduced. Further, because the CPU does not need to move the data through the full communication stack the amount of CPU processing capability required relative to the peripheral resource performance is reduced, so that the problem of miss-match between the processing capability of the CPU and the performance of the peripheral resources may also be reduced or avoided.

Such an architecture can then also plug-in other features to either the control/data plane and further extend the features of the heterogeneous bridge—for example, exposing a disk to a CPU that is created from a network distributed pool of other network types and/or disks. This proposed architecture, could also therefore deliver this “virtualized” disk directly to another resource type such as a storage-tape resource or accelerator resource.

The proposed architecture enables a smart switch that is not limited to switching only data between ports that use the same lower layers of communication stacks and thus is able to support two new operating concepts.

One concept is that the smart switch can operate as a heterogeneous resource smart switch which can bridge the sessions of multiple communication stacks between multiple resources of different types in an Open Systems Interconnection (OSI) model consistent manner. Thus, the smart switch can bridge between sessions of multiple applications between multiple different types of resources, and not just from a single bridge between two session types.

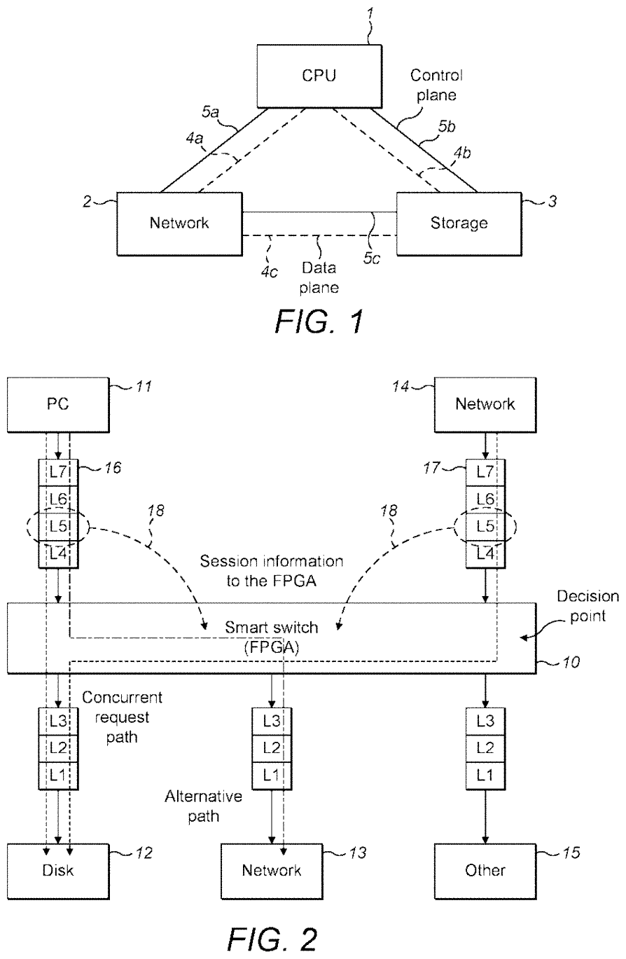

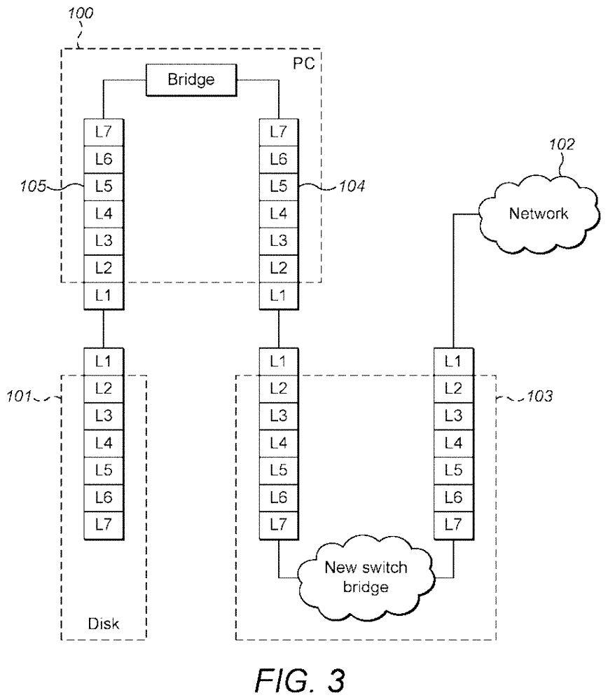

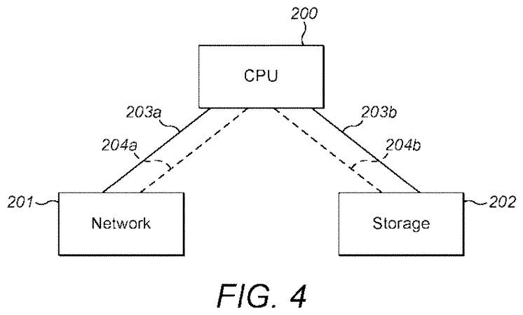

FIG. 1 shows a conceptual illustration of a computer system architecture provided by a smart switch according to this concept. As shown in FIG. 1, a Central Processing Unit (CPU) 1 is connected to two heterogenous peripheral resources, in the example of FIG. 1 a network adapter or network port 2 and a data store 3. The smart switch is able to bridge directly between sessions of different applications on the network port 2 and the data store 3. Accordingly, the smart switch provides a data plane 4c and a control plane 5c linking the network port 2 and the data store 3, in addition to the conventional data plane 4a and control plane 5a linking the network port 2 to the CPU 1 and data plane 4b and control plane 5b linking the data store 3 to the CPU 1.

Another concept is that the smart switch can share sessions to provide alternative entry points into the resource's communication stack. For example, the smart switch can merge sessions at layer 5 within the smart switch (because the smart switch looks at, or has information about, all the upper layers) and as such provide consistent and heterogeneous access to a single resource through different transports and media layers. For example, the smart switch can implement layers 1 to 4 for a solid-state drive (SSD) storage device and layers 1 to 4 for a network device, and within the layer 5 merge the control and data to support multiple sessions from different hosts at the same time, for example across a PC client using the Linux block 10 host layers 7 to 5, and a network client using a NAS protocol such as AoE through layers 5 to 7, and another client using yet another implementation of the host layers all at the same time to the same resource.

If two or more resources use the same protocol at the lower layers (1 to 4) then the merge can be implemented with increased efficiency at the lower level layer. For example, the smart switch can bridge a session from a client expecting to access a Network Attached Storage (NAS) or Network Address Translation (NAT) device, however the smart switch can either bridge to the local disk, or forward to another instance of the smart switch by simply merging at layer 3 the address of the resource, or provide a resilient copy of the data by duplicating the data to different address at layer 4.

This session layer merging can be static, or reconfigured by using for example a Field Programmable Gate Array (FPGA), and the control plane requirements for the merge can be implemented within the switch, in much the same way that OpenStack/OpenFlow enables advanced switching control for homogeneous OSI network stacks.

FIG. 1 shows a CPU 1 is connected to two heterogeneous peripheral resources 2 and 3 for clarity. In practice the computer system architecture may be used to connect a CPU more than two, or to any desired number, of heterogeneous peripheral resources.

Accordingly, the new computer system architecture enables the full performance theoretically available from the resources to be made available for use.

FIG. 2 shows a diagrammatic illustration of a computer system providing general bridging of computer resources at session layer 5 according to a first embodiment of the present invention.

In the illustrated example the computer system comprises a smart switch 10 arranged to enable the new computer system architecture. The smart switch 10 interconnects a central processing unit (CPU) 11 to a number of peripheral computer resources. In FIG. 2 the peripheral computer resources comprise a data store 12, first and second network ports 13 and 14, and other peripheral resources 15. In other examples there may be different numbers and types of peripheral resources. The data store 12 may, for example, be an SSD, or a disk drive.

The smart switch 10 comprises one or more field programmable gate arrays (FPGAs) forming a switch fabric. The switch fabric formed by the smart switch 10 is a crossbar switching matrix that allows each end point of the switch fabric a connection to any other end point, or any other interconnection scheme capable of transferring information between end points.

The smart switch 10 can be reconfigured by reconfiguring the FPGAs. In the illustrated example the smart switch 10 is configured to support the CPU and attached DISK and Network peripheral computer resources.

Using the terminology of the well-known Open Systems Interconnection (OSI) model, an overview of the operation of the smart switch 10 is that the layers 1 to 3 of each of the connected computer peripheral resources 12 to 15 are implemented in the switch fabric of the smart switch 1, while the layers 4 to 7 for each resource, along with the application, are implemented by the CPU 11. Accordingly, the smart switch 10 can switch layers 3 to 1 of the OSI stacks. The layers 1 to 3 are the physical layer 1, data link layer 2 and network layer 3, which are commonly referred to collectively as the lower or physical or media layers, and the layers 4 to 7 are the transport layer 4, session layer 5, presentation layer 6 and application layer 7, which are commonly referred to collectively as the upper or host layers or host stack.

The smart switch 10 can operate as a data plane switch between different physical layers 1 to 3 of the different peripheral computing resources with the operation of the smart switch 10 as a data plane switch being enabled by and based upon knowledge or context provided from the different host layers 4 to 7 associated with each of the peripheral computing resources 12 to 15. For standard resource or communication stacks the smart switch 10 can use the known specifications of the encoding of specific layers of the stack as a part of this knowledge. For example, for the known stack TCP over Ethernet, the smart switch 10 can use the known specifications of the encoded layer 3 message as a part of this knowledge. The smart switch 10 can use the knowledge or context from the host layers 4 to 7 to translate the format of data between two or more different layers 3 to 1 and/or different stacks without host processor involvement when all processor 10 resources pass through the smart switch.

In operation of the smart switch 10, the context of the host layer 4 to layer 7 stack can be shared with the smart switch 10 FPGA to implement control plane conversions and management of the associated session. This can be accomplished by modifying the host stack at layers 4 and 5, and providing the smart switch 10 with the information required to understand the data given to the layer 3 context.

In a specific example of operation of the computer system illustrated in FIG. 2, the data store 12, such as a disk, is a peripheral resource owned by the PC 11, and is accessed using the communication stack 16. The data store 12 is a Peripheral Component Interconnect Express (PCIe) layer 4 connected Non-Volatile Memory Express (NVMe) device at layer 5 in the linux block In/Out (10) layer 6 communication stack. The memory addresses of the layer 4 resource queues within the NVMe device communication stack 16 are provided to the smart switch 10 by the CPU 11. In this example, the smart switch 10 is then able to provide network access, to the network 14, to the same disk access session by using the same layer 5 context identifiers through the device Logical Unit Number (LUN) to link the block 10 of the storage device communication stack 16 and ATA over Ethernet (AoE) layer 5 session of the network port 14 communication stack 17, as illustrated by the dashed arrows 18 in FIG. 2. More complex associations can also be used, e.g. database record number with a file name, or NFS address with a iSCSI address, or various other session context combinations.

The network layer 1 to layer 3 network port 14 then uses a standard, for example, ATA over Ethernet (AoE) layer 4 transport which specifies the layer 3 encoding. The smart switch 1 is then able to merge the AoE layer 5 session context with a context passed from the layer 5 linux block 10. Because both accesses use the same NVMe layer 5 context, the smart switch 10 can provide shared access within the same PC context. For example, the client application can use the Linux presentation layer for file 10 and manipulate the resource, but can also use (or another client can use) the AoE path to also manipulate the same resource, and therefore can create a fast path to the same resource for file access by providing an alternative, and faster path for data to move to or from the resource through intermediate layers of other managed communication stacks. The context shared with the smart switch in the above example would include the location and mechanism to interface with layer 3 of the storage communication stack in addition to the per-session context such as the file-handle used at the linux block 10 layer 6. The shared context for a network communication stack would be the port address of the TCP endpoint at the associated MAC address. In more complex examples the smart switch 10 can switch between more than two communication stacks accessing different peripheral resources, or merge data flow between multiple sessions.

In addition, the smart switch 10 can implement a virtualization between the physical layers and the host layers so that the context of the resource in the host layers does not have a direct association with the context in the physical layers. This enables the smart switch 10 to make control decisions regarding which physical layer to forward host requests to. For example, if that same Linux application using the block 10 host layer 6 requests a read on a resource now using the virtualized context, then the smart switch 10 can forward the request to another similar smart switch at another location through the network stack rather than simply forwarding to the physical layer of the local data store 3 physical layer. Also, because this context of the session is available directly on the AoE network too, then the virtualized host block device can be distributed across the network. This can be implemented for example with a lookup table that maps a specific range of the LUN to a specific instance of the resource at a given network location. E.g., LUN addresses 0 to 100 at an Ethernet Media Access Control (MAC) address x, 101-1000 at MAC address y, and when y receives a request it, for example, can subtract a “virtualization offset 100”, and access the local resource at LUN address 1 to 900. More complex virtualization schemes are also possible.

In the described embodiments of the invention the computer system architecture is supported by a smart switch. In other examples plural switches may be used. In alternative examples different forms of reconfigurable hardware may be used instead of, or in addition to, the switch.

In some examples the reconfigurable hardware, such as the smart switch, may be configured only once before the first use of the reconfigurable hardware, and are not reconfigured again during normal use. In some examples the configuring maybe decided when the computer system is designed or manufactured. In other examples the reconfigurable hardware may be configured during use, for example when changes are made to the computer system.

In the described embodiments of the invention the smart switch comprises one or more FPGAs. In other examples different forms of switch may be used instead of, or in addition to FPGAs.

In the described embodiments of the invention the stacks are referred to as communication stacks. In other examples other types of multiple abstraction layer stacks may be used.

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A computer system comprising:
a processor;
a plurality of peripheral resources; and
reconfigurable hardware interconnecting the processor and the plurality of peripheral resources;
wherein the reconfigurable hardware is arranged to define a control plane interconnecting the plurality of peripheral resources and a data plane interconnecting the processor and the plurality of peripheral resources, and to carry out bridging between the plurality of peripheral resources through the data plane; and
the processor is arranged to control the bridging through the control plane.

2. The computer system according to claim 1, wherein the reconfigurable hardware is arranged to switch between host layers of two or more peripheral communication stacks that are used to access the peripheral resources to carry out the bridging between the plurality of peripheral resources.

3. The computer system according to claim 2, wherein the stacks are Open Systems Interconnection (OSI) model stacks.

4. The computer system according to claim 3, wherein the reconfigurable hardware is arranged to switch layers 3 to 1 of the OSI model stacks.

5. The computer system according to claim 4, wherein the reconfigurable hardware is able to translate the format of the data between two or more of layers 3 to 1 using the context passed from the host layers of the OSI model stacks

6. The computer system according to claim 3, wherein the reconfigurable hardware is arranged to connect one or more host layers of a stack used to access one peripheral resource to one or more physical layers of a stack used to access another peripheral resource to carry out the bridging.

7. The computer system according to claim 1, wherein the plurality of peripheral resources comprise heterogeneous peripheral resources.

8. The computer system according to claim 1 where the reconfigurable hardware can be configured only once at either design time, or before the first operations of the smart switch.

9. The computer system according to claim 1, wherein the reconfigurable hardware comprises a switch.

10. The computer system according to claim 1, wherein the switch comprises one or more Field Programmable Gate Arrays (FPGAs).

11. The computer system according to claim 1, wherein the processor comprises a Central Processing Unit (CPU).

12. A method for carrying out bridging between a plurality of peripheral resources, the method comprising:
providing reconfigurable hardware interconnecting the plurality of peripheral resources and a processor and defining a control plane interconnecting the plurality of peripheral resources and a data plane interconnecting the processor and the plurality of peripheral resources;
operating the reconfigurable hardware under the control of the processor through the control plane to carry out bridging between the plurality of peripheral resources through the data plane.

13. The method according to claim 12, wherein carrying out the bridging between the plurality of peripheral resources by the reconfigurable hardware comprises switching between host layers of two or more peripheral communication stacks that are used to access the peripheral resources.

14. The method according to claim 13, wherein the stacks are OSI model stacks.

15. The method according to claim 14, wherein the reconfigurable hardware switches layers 3 to 1 of the OSI model stacks.

16. The method according to claim 15, wherein the reconfigurable hardware translates the format of the data between two or more of layers 3 to 1 using the context passed from the host layers of the OSI model stacks.

17. The method according to claim 14, wherein carrying out the bridging by the reconfigurable hardware comprises connecting one or more host layers of a stack used to access one peripheral resource to one or more physical layers of a stack used to access another peripheral resource.

18. The method according to claim 12, wherein the plurality of peripheral resources comprise heterogeneous peripheral resources.

19. The method according to claim 12, wherein the reconfigurable hardware can be configured only once at either design time, or before the first operations of the smart switch.

20. A method for carrying out bridging between a plurality of peripheral resources interconnected by reconfigurable hardware defining a control plane interconnecting the plurality of peripheral resources and a data plane interconnecting a processor and the plurality of peripheral resources, the method comprising:
operating the reconfigurable hardware under the control of the processor through the control plane to carry out bridging between the plurality of peripheral resources through the data plane.

21. The method according to claim 20, wherein carrying out the bridging between the plurality of peripheral resources by the reconfigurable hardware comprises switching between host layers of two or more peripheral communication stacks used to access the peripheral resources.

22. The method according to claim 21, wherein the stacks are OSI model stacks.

23. The method according to claim 22, wherein the reconfigurable hardware switches layers 3 to 1 of the OSI model stacks.

24. The method according to claim 23, wherein the reconfigurable hardware translates the format of the data between two or more of layers 3 to 1 using the context passed from the host layers of the OSI model stacks.

25. The method according to claim 22, wherein carrying out the bridging by the reconfigurable hardware comprises connecting one or more host layers of a stack used to access one peripheral resource to one or more physical layers of a stack used to access another peripheral resource.

26. The method according to claim 20, wherein the plurality of peripheral resources comprise heterogeneous peripheral resources.

27. The method according to claim 20, wherein the reconfigurable hardware can be configured only once at either design time, or before the first operations of the smart switch.

28. A computer program comprising computer readable instructions which, when executed on a processor, will cause the processor to carry out the method of claim 20.
